(19) United States
(12) Patent Application Publication
(10) Pub. No.: US 2016/0025901 A1
(43) Pub. Date: Jan. 28, 2016

(54) ELECTROOPTICAL DEVICE, AND ELECTRONIC APPARATUS

(71) Applicant: Seiko Epson Corporation, Tokyo (JP)

(72) Inventor: Yoshikazu Eguchi, Fujimi-machi (JP)

(21) Appl. No.: 14/795,866

(22) Filed: Jul. 9, 2015

(30) Foreign Application Priority Data
Jul. 25, 2014 (JP) 2014-151562

(51) Int. Cl. G02B 1/16; G02B 26/08; G02B 27/00

(52) U.S. Cl. CPC G02B 1/16; G02B 27/0006; G02B 26/0833

(57) ABSTRACT

An electrooptical device includes a substrate, a mirror that is arranged so as to be separated from the substrate on one surface of the substrate, a side wall that is arranged between the substrate and the mirror, and has a portion which is connected to a portion of the mirror so as to support the mirror, a light transmitting cover base material that seals at least the side wall and the mirror, and a first transparent stacked film that is arranged on one surface of the cover base material, in which the first transparent stacked film includes a conductive film.

### BACKGROUND

1. Technical Field

The present invention relates to an electrooptical device, and an electronic apparatus.

2. Related Art

As an electronic apparatus described above, for example, a projector where light which is emitted from a light source, is concentrated with an optical deflection device which is referred to as a digital micro mirror device (DMD) as an electrooptical device, and is enlarged and projected by a projection optical system, and thereby, colors are displayed on a screen, is known.

The optical deflection device is a device where a plurality of micro mirrors are arrayed in a matrix shape. In order to prevent that dust (contaminants) from an outside is attached to the plurality of micro mirrors, the optical deflection device is known to include a cover which seals the micro mirror.

For example, in JP-A-2012-242223, a technology of suppressing static electricity which is generated at the time of sealing a package of a MEMS element, by arranging an electrically connected silver paste in a sealing package such as a resin, and reducing a malfunction due to the static electricity of the MEMS element, is disclosed.

However, if a transmissive insulating material (for example, glass such as SiO₂) is covered onto a display device such as the optical deflection device, there are problems that the dust is attached to the cover by the static electricity, and the projected display is adversely affected (transmittance is reduced). Moreover, there is the problem that the optical deflection device which is operated by the static electricity, is adversely affected.

### SUMMARY

The invention can be realized in the following forms or application examples.

### APPLICATION EXAMPLE 1

According to this application example, there is provided an electrooptical device including a substrate, a mirror that is arranged so as to be separated from the substrate on one surface of the substrate, a supporting portion that is arranged between the substrate and the mirror, and has a portion which is connected to a portion of the mirror so as to support the mirror, a light transmitting cover that seals at least the supporting portion and the mirror, and a first transparent stacked film that is arranged on one surface of the cover, in which the first transparent stacked film includes a conductive film.

According to the application example, since the first transparent stacked film including the conductive film, is arranged in the cover, it is possible to suppress electrification by static electricity which is generated during a process, and it is possible to prevent dust from being attached to the cover. Moreover, since the electrification of the static electricity is suppressed, it is possible to prevent the device or the like which is operated by the static electricity from being adversely affected. Still more, since the first transparent stacked film is arranged in the cover, it is possible to enhance transmittance of light, and it is possible to reflect the transmitted light with the mirror.

### APPLICATION EXAMPLE 1

In the electrooptical device according to the application example, it is preferable that the first transparent stacked film includes a first light transmitting film, a second light transmitting film which is arranged between the first light transmitting film and the mirror, and of which a refractive index is higher than that of the first light transmitting film, and a third light transmitting film which is arranged between the second light transmitting film and the mirror, and of which a refractive index is lower than that of the second light transmitting film, and the second light transmitting film is a conductive film.

According to the application example, since the first transparent stacked film is configured of a stacked film having a refractional relationship described above, the reflection of the light is suppressed at an interface of the film, and it is possible to enhance the transmittance of the light.

### APPLICATION EXAMPLE 3

In the electrooptical device according to the application example, it is preferable that the first light transmitting film is formed of a silicon oxide, the second light transmitting film is formed of an ITO, and the third light transmitting film is formed of a silicon oxide.

According to the application example, since the light transmitting films are obtained by stacking materials described above, the reflection of the light is suppressed at the interface of the film, and it is possible to enhance the transmittance of the light.

### APPLICATION EXAMPLE 4

In the electrooptical device according to the application example, it is preferable that when n1 represents a refractive index of the second light transmitting film, and d1 represents a film thickness (nm) of the second light transmitting film, a relationship of n1·d1=190 nm to 330 nm, is satisfied.

According to the application example, by setting the film so as to be an optical film thickness described above, it is possible to enhance the transmittance of the first transparent stacked film.

### APPLICATION EXAMPLE 5

In the electrooptical device according to the application example, it is preferable that the first transparent stacked film includes a fourth light transmitting film, a fifth light transmitting film which is arranged between the fourth light transmitting film and the mirror, and of which a refractive index is higher than that of the fourth light transmitting film, a sixth light transmitting film which is arranged between the fifth light transmitting film and the mirror, and of which a refractive index is lower than that of the fifth light transmitting film, a seventh light transmitting film which is arranged between the sixth light transmitting film and the mirror, and of which a refractive index is higher than that of the sixth light transmitting film, and an eighth light transmitting film which is arranged between the seventh light transmitting film and the mirror, and of which a refractive index is lower than that of the seventh light transmitting film, and the fifth light transmitting film is a conductive film.

According to the application example, since the first transparent stacked film is configured of the stacked film having the refractional relationship described above, the reflection of the light is suppressed at the interface of the film, and it is possible to enhance the transmittance of the light. Furthermore, it is possible to enhance the transmittance in a wide wavelength range.

### APPLICATION EXAMPLE 6

In the electrooptical device according to the application example, it is preferable that the fourth light transmitting film is formed of a silicon oxide, the fifth light transmitting film is formed of an ITO, the sixth light transmitting film is formed of a silicon oxide, the seventh light transmitting film is formed of an ITO, and the eighth light transmitting film is formed of a silicon oxide.

According to the application example, since the first transparent stacked film is obtained by stacking the materials described above, the reflection of the light is suppressed at the interface of the film, and it is possible to enhance the transmittance of the light.

### APPLICATION EXAMPLE 7

In the electrooptical device according to the application example, it is preferable that when n1 represents a refractive index of the fifth light transmitting film, and d1 represents a film thickness (nm) of the fifth light transmitting film, when n2 represents a refractive index of the sixth light transmitting film, and d2 represents a film thickness (nm) of the sixth light transmitting film, and when n3 represents a refractive index of the seventh light transmitting film, and d3 represents a film thickness (nm) of the seventh light transmitting film, relationships of n1·d1+n2·d2=95 nm to 188 nm, and n2·d2+n3·d3=95 nm to 188 nm, are satisfied.

According to the application example, by setting the film so as to be the optical film thickness described above, it is possible to enhance the transmittance of the first transparent stacked film. Furthermore, it is possible to enhance the transmittance in the wide wavelength range.

### APPLICATION EXAMPLE 8

In the electrooptical device according to the application example, it is preferable that the first transparent stacked film is arranged on a surface of the cover, the surface facing the substrate side.

According to the application example, since the first transparent stacked film is arranged on the surface of the cover, the surface facing the substrate side, it is possible to enhance the transmittance.

### APPLICATION EXAMPLE 9

In the electrooptical device according to the application example, it is preferable that a second transparent stacked film that is arranged on a surface of the cover, the surface being opposite to the substrate side, is further included.

According to the application example, since the second transparent stacked film is arranged on the surface of the cover, the surface being opposite to the substrate side, the dust is unlikely to be attached to the cover. Moreover, there is no need for adjustment of blurring a focus for a dust countermeasure, and a whole of the cover can be thinned.

### APPLICATION EXAMPLE 10

According to the application example, there is provided an electronic apparatus including the electrooptical device described above.

According to this application example, it is possible to provide the electronic apparatus that is capable of enhancing display quality.

### BRIEF DESCRIPTION OF THE DRAWINGS

The invention will be described with reference to the accompanying drawings, wherein like numbers reference like elements.

FIG. 1 is schematic diagram illustrating an optical system of a projector as an electronic apparatus.

FIG. 2 is a schematic diagram illustrating a configuration of an optical deflection device as an electrooptical device.

FIG. 3 is a schematic cross-sectional view which is taken along a III-III line of the optical deflection device illustrated in FIG. 2.

FIG. 4 is an enlarged cross-sectional view enlarging and illustrating a IV portion of the optical deflection device illustrated in FIG. 3.

FIG. 5 is an enlarged cross-sectional view enlarging and illustrating the V portion of the optical deflection device illustrated in FIG. 3.

FIG. 6 is an enlarged cross-sectional view enlarging and illustrating a VI portion of the optical deflection device illustrated in FIG. 3.

FIG. 7 is a schematic cross-sectional view illustrating a reflection state of a transparent stacked film which configures a cover of FIG. 6.

FIG. 8 is a schematic cross-sectional view illustrating a configuration of an optical deflection device according to a second embodiment.

FIG. 9 is a schematic cross-sectional view illustrating a reflection state of a transparent stacked film which configures a cover.

FIG. 10 is a schematic cross-sectional view illustrating a configuration of a cover according to Modification Example.

### DESCRIPTION OF EXEMPLARY EMBODIMENTS

Hereinafter, embodiments embodying the invention, will be described with reference to drawings. Furthermore, the used drawings are displayed by appropriately being enlarged or reduced, so as to make the described portion to be in an identifiable state.

In the following embodiments, for example, a case of being described as “on substrate”, indicates the case of being arranged on a substrate so as to come into contact with the substrate, or the case of being arranged through other components on the substrate, or the case where a portion is arranged on the substrate so that the portion comes into contact with the substrate, or the case where a portion is arranged through other components on the substrate.

### First Embodiment

### Configuration of Projector as Electronic Apparatus

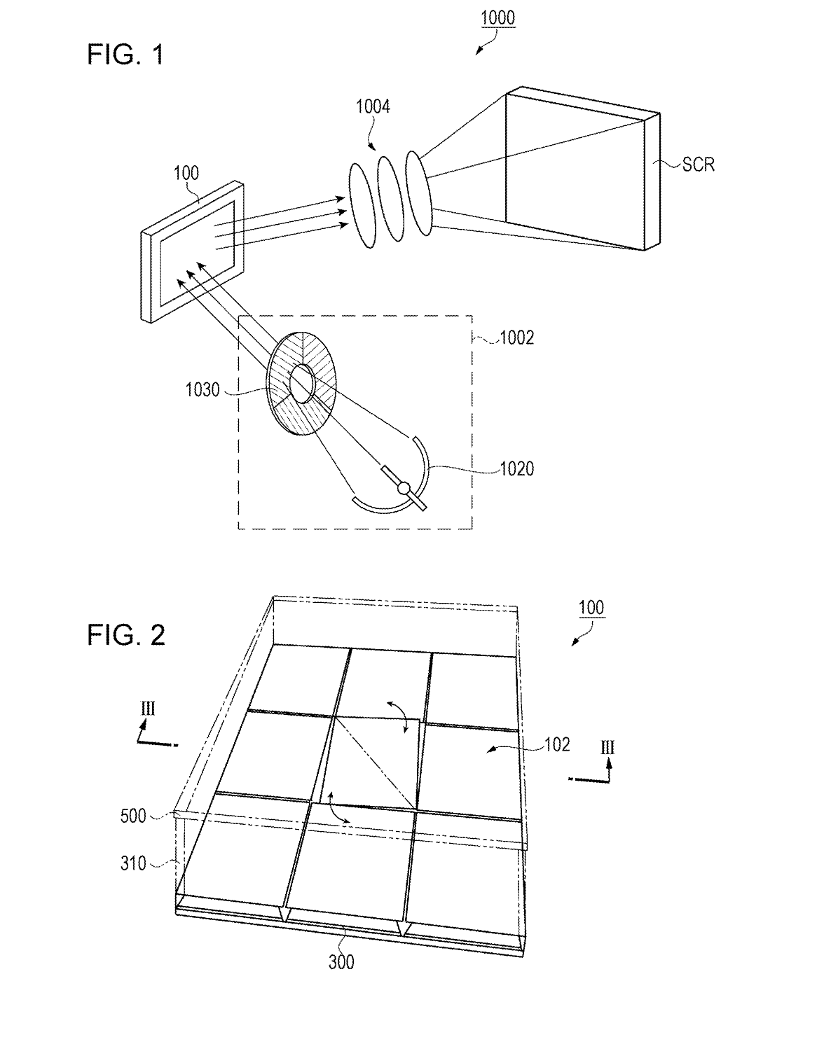

FIG. 1 is a schematic diagram illustrating an optical system of a projector as an electronic apparatus. Hereinafter, the optical system of the projector will be described with reference to FIG. 1.

As illustrated in FIG. 1, a projector 1000 is configured to include a light source device 1002, an optical deflection device 100 that modulates light which is emitted from the light source device 1002 depending on image information, and a projection optical system 1004 that projects the modulated light from the optical deflection device 100 as a projection image.

The light source device 1002 includes a light-emitting element 1020, and a fluorescent body substrate 1030. The light source device 1002 is a laser light source that emits blue laser light (peak of light-emitting intensity: for example, approximately 445 nm). On an optical path of the laser light which is emitted from the light-emitting element 1020, the fluorescent body substrate 1030 is arranged.

Moreover, if being the light having a wavelength which can excite a fluorescent material described later, the light-emitting element 1020 may be a excitation light source that emits the color light having the peak wavelength other than 445 nm. Still more, as a method for brightening the projection image, three optical deflection devices may be used.

### Configuration of Optical Deflection Device as Electrooptical Device

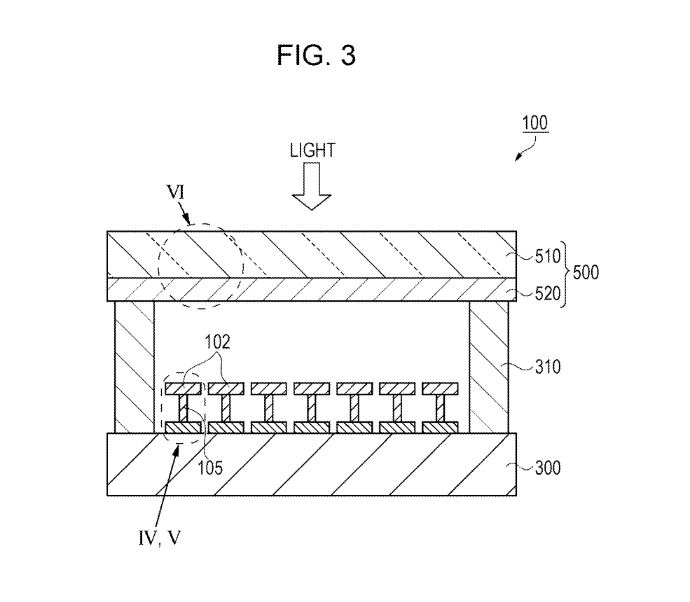

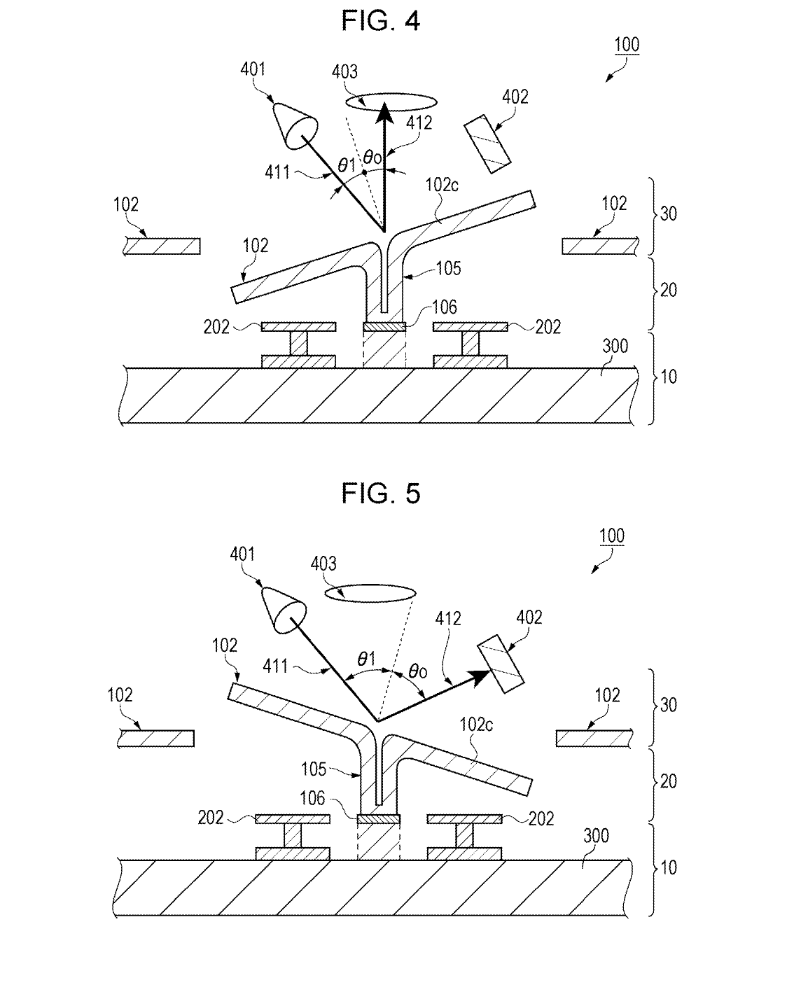

FIG. 2 is a schematic diagram illustrating a configuration of an optical deflection device as an electrooptical device. FIG. 3 is a schematic cross-sectional view which is taken along a III-III line of the optical deflection device illustrated in FIG. 2. FIG. 4 and FIG. 5 are schematic cross-sectional views (B portion) which are taken along IV-IV and V-V lines of the optical deflection device illustrated in FIG. 3, and are schematic cross-sectional views illustrating an operation of a mirror of the optical deflection device. Hereinafter, the configuration and the operation of the optical deflection device, will be described with reference to FIG. 2 to FIG. 5.

As illustrated in FIG. 2, in an optical deflection device (DMD) 100, on an upper side of a substrate 300, a mirror 102 is supported into a matrix shape through a hinge 106, and a support 105 as a supporting portion (see FIG. 4, regarding the components). Furthermore, the components are sealed by using a side wall 310 and a cover 500, so as to surround the components (see FIG. 2 and FIG. 3).

As illustrated in FIG. 4, the optical deflection device 100 of a first embodiment, includes three main portions of a bottom portion 10 including a control circuit, an intermediate portion 20 including an electrode 202 and the hinge 106, and an upper portion 30 that is covered by the mirror 102 including an embedded torsion hinge and a cavity.

In order to selectively control the operation of each mirror 102 of the optical deflection device 100, the bottom portion 10 has the substrate 300 including an address designation circuit. The address designation circuit includes a memory cell for a communication signal, and wiring of a word line or a bit line. The electrical address designation circuit on the substrate 300, can be assembled by using a standard CMOS technology, and is similar to a static random access memory (SRAM).

The intermediate portion 20 is configured of the electrode 202, the hinge 106, and the support 105. The electrode 202 is designed so as to enhance capacitive coupling efficiency of an electrostatic torque during angle crossing transition. By lifting up a surface of the electrode 202 in the vicinity of the hinge 106 region, a space between the mirror 102 and the electrode 202, is effectively narrowed. Since electrostatic attraction is in inverse proportion to square between the mirror 102 and the electrode 202, an influence is clear when the mirror 102 is inclined at a landing position.

The upper portion 30 is covered by the mirror 102 that is configured of a stacked film which includes a third mirror film 102c as a flat reflective metal film on an upper surface. The hinge 106 of the mirror 102 is formed so as to be a portion of the mirror 102. Additionally, on a lower side of the mirror 102, a gap which only rotates a predetermined angle by retaining a minimum distance, is given.

When a directional light 411 from an illumination light source 401, forms an incident angle 81, FIG. 4 illustrates a cross-sectional view of a portion of the optical deflection device 100 based on one embodiment of the invention. When the optical deflection device 100 is measured in a normal direction, a deflected light 412 has an angle 80. In a digital operation mode, the configuration is generally referred to as an “On” position.

During the operation in which the mirror 102 is rotated toward another electrode 202 below the side which is opposite to the hinge 106, FIG. 5 illustrates a cross-sectional view of the same portion of the optical deflection device 100. The directional light 411 and the deflected light 412 form more larger angles θ1 and θo. The deflected light 412 is emitted toward a light absorbing device 402.

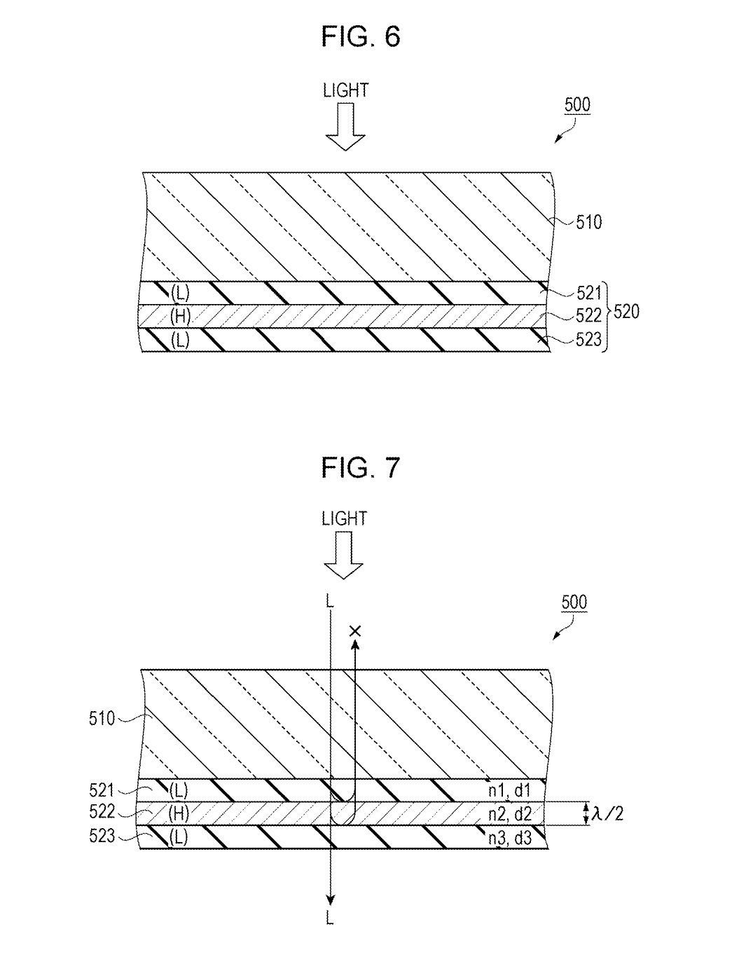

FIG. 6 is a schematic cross-sectional view enlarging and illustrating a VI portion of the optical deflection device illustrated in FIG. 3. FIG. 7 is a schematic cross-sectional view illustrating a reflection state of a transparent stacked film which configures a cover of FIG. 6. Hereinafter, the configuration of the cover will be described with reference to FIG. 6 and FIG. 7.

As illustrated in FIG. 6, a cover 500 has a cover base material 510 (cover), and a transparent stacked film 520 as a first transparent stacked film which is arranged on the cover base material 510 (mirror 102 side). In the cover base material 510, a transparent substrate such as a glass substrate or a quartz substrate, is used. A thickness of the cover base material 510 is approximately 0.7 mm to 1.2 mm.

The transparent stacked film 520 is configured of a first light transmitting film 521 from the cover base material 510 side, a second light transmitting film 522, and a third light transmitting film 523. The light is guided to the mirror 102 through the transparent stacked film 520 from the cover base material 510, and the light which is reflected with the mirror 102, is emitted through the transparent stacked film 520 and the cover base material 510.

For example, the material of the first light transmitting film 521 is a silicon oxide (SiO₂). For example, the material of the second light transmitting film 522 is a transparent conductive film (ITO: Indium Tin Oxide). For example, the material of the third light transmitting film 523 is a silicon oxide (SiO₂). In order to remove static electricity which is electrified in the cover 500, the second light transmitting film 522 is electrically connected to the optical deflection device 100.

The second light transmitting film 522 is a conductive film which is arranged between the first light transmitting film 521 and the third light transmitting film 523, and of which a refractive index is higher than that of the first light transmitting film 521. The third light transmitting film 523 is a film which is arranged between the second light transmitting film 522 and the mirror 102, and of which the refractive index is lower than that of the second light transmitting film 522.

For example, the refractive index of the ITO is approximately 1.9. For example, the refractive index of the SiO₂ is approximately 1.4. A light anti-reflective structure is configured by stacking the light transmitting films 521, 522 and 523 of which the refractive indexes are different from each other in this manner. Film thicknesses of the respective light transmitting films 521, 522 and 523 configuring the cover 500, are set so that transmittance becomes the maximum in a wavelength band of the light which is subject to the modulation. Specifically, it is preferable that a high transmittance condition is satisfied in a range of the visible light (450 nm to 650 nm, preferably 380 nm to 750 nm), and a low transmittance condition is not applicable thereto.

Here, n (n1) represents the refractive index of the second light transmitting film 522, and d (d1) represents the film thickness of the second light transmitting film 522. In this case, it is preferable that a mathematical expression of n·d (optical film thickness)=190 nm to 330 nm, is satisfied. Hereby, it is possible to enhance the transmittance of the cover 500.

In this manner, as illustrated in FIG. 7, the theoretical reflected light at an interface between the first light transmitting film 521 and the second light transmitting film 522, and the theoretical reflected light at the interface between the second light transmitting film 522 and the third light transmitting film 523, are efficiently offset to each other. As a result, it is possible to pass through a light L.

As detailedly described above, according to the optical deflection device 100 and the electronic apparatus of the first embodiment, effects which are illustrated below, are obtained.

(1) According to the optical deflection device 100 of the first embodiment, since the transparent stacked film 520 including the transparent conductive film (ITO), is arranged in the cover 500, it is possible to suppress the electrification by the static electricity which is generated during a process, and it is possible to prevent dust (contaminants) from being attached to the cover 500. Moreover, since the electrification of the static electricity is suppressed, it is possible to prevent the device or the like which is operated by the static electricity, from being adversely affected. Still more, since the transparent stacked film 520 is arranged in the cover 500, the reflection of the light is suppressed at the interface of the film, and it is possible to enhance the transmittance of the light. Specifically, it is possible to obtain properties of which the transmittance is high with respect to a certain wavelength.

(2) According to the electronic apparatus of the present embodiment, since the above-described optical deflection device 100 is included, it is possible to provide the electronic apparatus that is capable of enhancing display quality.

### Second Embodiment

### Configuration of Optical Deflection Device

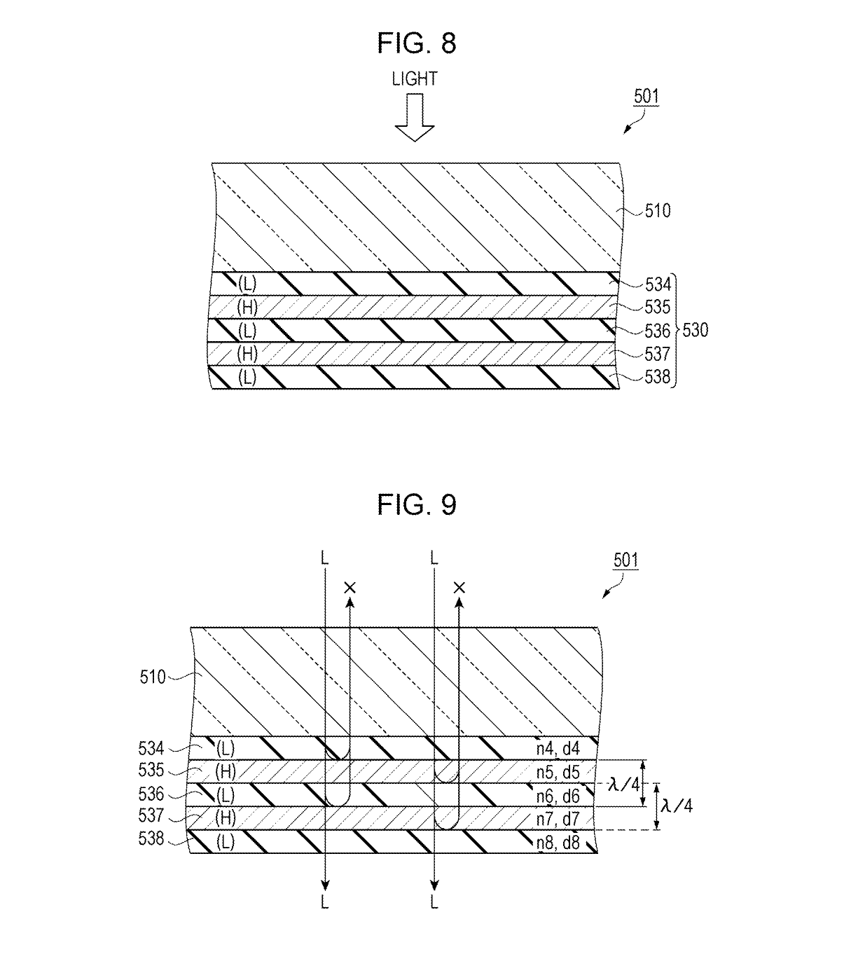

FIG. 8 is a schematic cross-sectional view illustrating a configuration of an optical deflection device (particularly, cover) according to a second embodiment. FIG. 9 is a schematic cross-sectional view illustrating a reflection state of a transparent stacked film which configures a cover. Hereinafter, the configuration of the cover according to the second embodiment, will be described with reference to FIG. 8 and FIG. 9.

In a cover 501 of the second embodiment, the configuration of a transparent stacked film 530 is different, and other configurations are generally similar thereto, in comparison with the above-described first embodiment. Hence, in the second embodiment, a portion which is different from the first embodiment, will be described in detail, and the descriptions of other overlapping portions will be appropriately omitted.

As illustrated in FIG. 8, the cover 501 has the cover base material 510, and the transparent stacked film 530 which is arranged on the cover base material 510 (lower side in FIG. 8).

The transparent stacked film 530 is configured of a fourth light transmitting film 534 from the cover base material 510 side, a fifth light transmitting film 535, a sixth light transmitting film 536, a seventh light transmitting film 537, and an eighth light transmitting film 538. The light is guided to the mirror 102 through the transparent stacked film 530 from the cover base material 510, and the light which is reflected with the mirror 102, is emitted through the transparent stacked film 530 and the cover base material 510.

For example, the material of the fourth light transmitting film 534 is a silicon oxide (SiO2). For example, the material of the fifth light transmitting film 535 is a transparent conductive film (ITO: Indium Tin Oxide). For example, the material of the sixth light transmitting film 536 is a silicon oxide (SiO₂). For example, the material of the seventh light transmitting film 537 is a transparent conductive film (ITO). For example, the material of the eighth light transmitting film 538 is a silicon oxide (SiO₂).

The fifth light transmitting film 535 is a conductive film which is arranged between the fourth light transmitting film 534 and the sixth light transmitting film 536, and of which the refractive index is higher than that of the fourth light transmitting film 534. The sixth light transmitting film 536 is an insulating film which is arranged between the fifth light transmitting film 535 and the seventh light transmitting film 537, and of which the refractive index is lower than that of the fifth light transmitting film 535. The seventh light transmitting film 537 is a conductive film which is arranged between the sixth light transmitting film 536 and the eighth light transmitting film 538, and of which the refractive index is higher than that of the sixth light transmitting film 536. The eighth light transmitting film 538 is an insulating film which is arranged between the seventh light transmitting film 537 and the mirror 102, and of which the refractive index is lower than that of the seventh light transmitting film 537.

In order to remove the static electricity which is electrified in the cover 501, the fifth light transmitting film 535 and the seventh light transmitting film 537 are electrically connected to the optical deflection device 100.

For example, the refractive index of the ITO is approximately 1.9. For example, the refractive index of the SiO₂ is approximately 1.4. The light anti-reflective structure is configured by stacking the light transmitting films of which the refractive indexes are different from each other in this manner. The film thicknesses of the respective light transmitting films (530) configuring the cover 501, are set so that the transmittance becomes the maximum in the wavelength band of the light which is subject to the modulation. Specifically, it is preferable that the high transmittance condition is satisfied in the range of the visible light (450 nm to 650 nm, preferably 380 nm to 750 nm), and the low transmittance condition is not applicable thereto.

Here, n5 (n1) represents the refractive index of the fifth light transmitting film 535, and d5 (d1) represents the film thickness of the fifth light transmitting film 535. n6 (n2) represents the refractive index of the sixth light transmitting film 536, and d6 (d2) represents the film thickness of the sixth light transmitting film 536. n7 (n3) represents the refractive index of the seventh light transmitting film 537, and d7 (d3) represents the film thickness of the seventh light transmitting film 537. In this case, it is preferable that the mathematical expression of n5·d5+n6·d6=95 nm to 188 nm, and n6·d6+n7·d7=95 nm to 188 nm, is satisfied. Hereby, it is possible to enhance the transmittance of the cover 501.

In this manner, as illustrated in FIG. 9, the theoretical reflected light at the interface between the fourth light transmitting film 534 and the fifth light transmitting film 535, and the theoretical reflected light at the interface between the sixth light transmitting film 536 and the seventh light transmitting film 537, are efficiently offset to each other. In other words, the theoretical reflected lights are offset to each other by reversing mutual phases. As a result, it is possible to pass through the light L.

Moreover, the theoretical reflected light at the interface between the fifth light transmitting film 535 and the sixth light transmitting film 536, and the theoretical reflected light at the interface between the seventh light transmitting film 537 and the eighth light transmitting film 538, are efficiently offset to each other. As a result, it is possible to pass through the light L. In this case, for example, the transmittance becomes the maximum at the wavelength of 550 nm (green color).

As detailedly described above, according to the optical deflection device 100 of the second embodiment, the effects which are illustrated below, are obtained.

(3) According to the optical deflection device 100 of the second embodiment, since the transparent stacked film 530 is configured of the stacked film having the refractional relationship described above, the reflection of the light is suppressed at the interface of the film, and it is possible to enhance the transmittance of the light. Additionally, it is possible to enhance the transmittance in the wide wavelength range, in comparison with the cover 500 of the first embodiment.

Furthermore, the embodiments of the invention are not limited to the embodiments described above, and may be appropriately modified within the scope without departing from the gist or the idea of the invention which is read from the claims and the entire specification, and are included in the technical scope of the embodiments of the invention. Moreover, the invention can be carried out by the following forms.

### MODIFICATION EXAMPLE 1

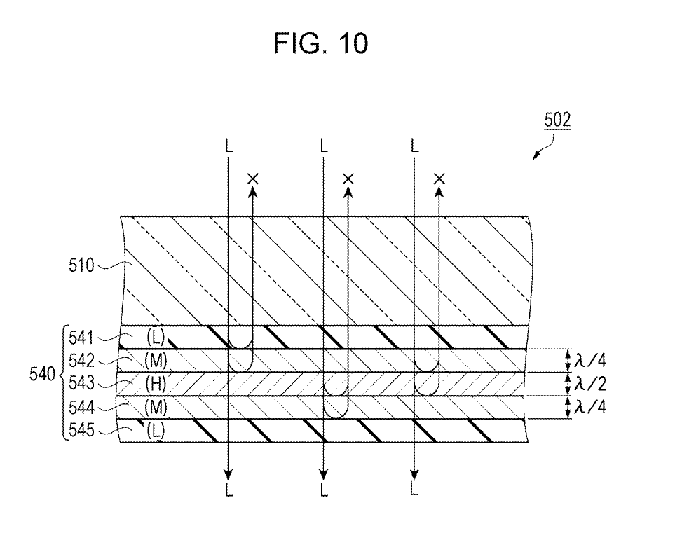

As described above, in the same manner as the first embodiment and the second embodiment, instead of configuring the transparent stacked films 520 and 530 by the stacked film of the insulating film (SiO₂) and the transparent conductive film (ITO), Modification Example 1 may be configured as illustrated in FIG. 10. FIG. 10 is a schematic cross-sectional view illustrating a configuration of a cover according to Modification Example. In a cover 502 illustrated in FIG. 10, the configuration of a transparent stacked film 540 is different, and other configurations are generally similar thereto, in comparison with the above-described covers 500 and 501.

As illustrated in FIG. 10, the cover 502 has the cover base material 510, and the transparent stacked film 540 which is arranged on the cover base material 510 (lower side in FIG. 10).

The transparent stacked film 540 is configured of an eleventh light transmitting film 541 from the cover base material 510 side, a twelfth light transmitting film 542, a thirteenth light transmitting film 543, a fourteenth light transmitting film 544, and a fifteenth light transmitting film 545. The light is guided to the mirror 102 through the transparent stacked film 540 from the cover base material 510, and the light which is reflected with the mirror 102, is emitted through the transparent stacked film 540 and the cover base material 510.

For example, the material of the eleventh light transmitting film 541 is a silicon oxide (SiO₂). For example, the material of the twelfth light transmitting film 542 is an aluminum oxide (Al₂O₃). For example, the material of the thirteenth light transmitting film 543 is a transparent conductive film (ITO). For example, the material of the fourteenth light transmitting film 544 is an aluminum oxide (Al₂O₃). For example, the material of the fifteenth light transmitting film 545 is a silicon oxide (SiO₂).

The twelfth light transmitting film 542 is a film which is arranged between the eleventh light transmitting film 541 and the thirteenth light transmitting film 543, and of which the refractive index is higher than that of the eleventh light transmitting film 541. The thirteenth light transmitting film 543 is a conductive film which is arranged between the twelfth light transmitting film 542 and the fourteenth light transmitting film 544, and of which the refractive index is higher than that of the twelfth light transmitting film 542. The fourteenth light transmitting film 544 is a film which is arranged between the thirteenth light transmitting film 543 and the fifteenth light transmitting film 545, and of which the refractive index is lower than that of the thirteenth light transmitting film 543. The fifteenth light transmitting film 545 is an insulating film which is arranged between the fourteenth light transmitting film 544 and the mirror 102, and of which the refractive index is lower than that of the fourteenth light transmitting film 544.

The refractive index of the ITO is approximately 1.9. The refractive index of the aluminum oxide is approximately 1.76. The refractive index of the SiO₂ is approximately 1.4. The light anti-reflective structure is configured by stacking the light transmitting films of which the refractive indexes are different from each other in this manner.

According to the cover 502 of the configuration described above, by adjusting the film thicknesses of the respective light transmitting films (540), the film thicknesses are set so that the transmittance becomes the maximum in the wavelength band of the light which is subject to the modulation. Hereby, it is possible to obtain the high transmittance in the wide wavelength band, in comparison with the cover 501 of the second embodiment.

### MODIFICATION EXAMPLE 2

As described above, it is not limited to that the transparent stacked films 520, 530 and 540 are arranged on an inner side (mirror 102 side) of the cover base material 510, and for example, a second transparent stacked film may be arranged only on an outer side (light incidence side) of the cover base material 510. Moreover, the first transparent stacked film may be arranged on the inner side of the cover base material 510, and the second transparent stacked film may be arranged on the outer side thereof. When the transparent stacked film is arranged on the outer side of the cover base material 510, since the dust is unlikely to be attached to the cover, there is no need for adjustment of blurring a focus for a dust countermeasure, and a whole of the cover can be thinned.

### MODIFICATION EXAMPLE 3

As described above, the silicon oxide (first light transmitting film 521) configuring the transparent stacked film 520, is arranged on the cover base material 510, but it is not limited thereto, and the silicon oxide is the same as the material of the cover base material 510, and the ITO (second light transmitting film 522) may be arranged on the cover base material 510.

### MODIFICATION EXAMPLE 4

As described above, it is not limited to that no component is put into the optical deflection device 100 which is sealed by the cover 500, and for example, the gas of the material may be filled therein so as to enhance the transmittance.

### MODIFICATION EXAMPLE 5

As described above, as an electronic apparatus to which the optical deflection device 100 is mounted, various types of the electronic apparatuses such as a head-up display (HUD), a head-mounted display (HMD), a mobile mini projector, an in-vehicle apparatus, an audio apparatus, a light exposing apparatus and an illumination apparatus, may be used, in addition to the projector 1000.

The entire disclosure of Japanese Patent Application No. 2014-151562, filed Jul. 25,2014 is expressly incorporated by reference herein.

What is claimed is:

1. An electrooptical device comprising:
a substrate;
a mirror that is arranged so as to be separated from the substrate on one surface of the substrate;
a supporting portion that is arranged between the substrate and the mirror, and has a portion which is connected to a portion of the mirror so as to support the mirror;
a light transmitting cover that seals at least the supporting portion and the mirror; and
a first transparent stacked film that is arranged on one surface of the cover,
wherein the first transparent stacked film includes a conductive film.

2. The electrooptical device according to claim 1,
wherein the first transparent stacked film includes
a first light transmitting film,
a second light transmitting film which is arranged between the first light transmitting film and the mirror, and of which a refractive index is higher than that of the first light transmitting film, and
a third light transmitting film which is arranged between the second light transmitting film and the mirror, and of which a refractive index is lower than that of the second light transmitting film, and
the second light transmitting film is a conductive film.

3. The electrooptical device according to claim 2,
wherein the first light transmitting film is formed of a silicon oxide,
the second light transmitting film is formed of an ITO, and
the third light transmitting film is formed of a silicon oxide.

4. The electrooptical device according to claim 2,
wherein when n1 represents a refractive index of the second light transmitting film, and d1 represents a film thickness (nm) of the second light transmitting film,
a relationship of n1·d1=190 nm to 330 nm, is satisfied.

5. The electrooptical device according to claim 1,
wherein the first transparent stacked film includes
a fourth light transmitting film,
a fifth light transmitting film which is arranged between the fourth light transmitting film and the mirror, and of which a refractive index is higher than that of the fourth light transmitting film,
a sixth light transmitting film which is arranged between the fifth light transmitting film and the mirror, and of which a refractive index is lower than that of the fifth light transmitting film,
a seventh light transmitting film which is arranged between the sixth light transmitting film and the mirror, and of which a refractive index is higher than that of the sixth light transmitting film, and
an eighth light transmitting film which is arranged between the seventh light transmitting film and the mirror, and of which a refractive index is lower than that of the seventh light transmitting film, and
the fifth light transmitting film is a conductive film.

6. The electrooptical device according to claim 5, wherein the fourth light transmitting film is formed of a silicon oxide,
the fifth light transmitting film is formed of an ITO,
the sixth light transmitting film is formed of a silicon oxide,
the seventh light transmitting film is formed of an ITO, and
the eighth light transmitting film is formed of a silicon oxide.

7. The electrooptical device according to claim 5,
wherein when n1 represents a refractive index of the fifth light transmitting film, and d1 represents a film thickness (nm) of the fifth light transmitting film,
when n2 represents a refractive index of the sixth light transmitting film, and d2 represents a film thickness (nm) of the sixth light transmitting film, and
when n3 represents a refractive index of the seventh light transmitting film, and d3 represents a film thickness (nm) of the seventh light transmitting film,
relationships of n1·d1+n2·d2=95 nm to 188 nm, and n2·d2+n3·d3=95 nm to 188 nm, are satisfied.

8. The electrooptical device according to claim 1,
wherein the first transparent stacked film is arranged on a surface of the cover, the surface facing the substrate side.

9. The electrooptical device according to claim 8, further comprising:
a second transparent stacked film that is arranged on a surface of the cover, the surface being opposite to the substrate side.

10. An electronic apparatus comprising:
trooptical device according to claim 1.

11. An electronic apparatus comprising:
trooptical device according to claim 2.

12. An electronic apparatus comprising:
trooptical device according to claim 3.

13. An electronic apparatus comprising:
trooptical device according to claim 4.

14. An electronic apparatus comprising:
trooptical device according to claim 5.

15. An electronic apparatus comprising:
trooptical device according to claim 6.

16. An electronic apparatus comprising:
trooptical device according to claim 7.

17. An electronic apparatus comprising:
trooptical device according to claim 8.

18. An electronic apparatus comprising:
trooptical device according to claim 9.
